(19) United States
(12) Patent Application Publication
(10) Pub. No.: US 2026/0287177 A1
(43) Pub. Date: Sep. 24, 2026

(54) METHOD FOR PERFORMING MECHANICAL WORK, ARRANGEMENT FOR PERFORMING MECHANICAL WORK, AND METHOD FOR CONVERTING MECHANICAL ENERGY INTO ELECTRICAL ENERGY

(71) Applicant: Udo HELLWIG, Berlin (DE)

(72) Inventor: Udo HELLWIG, Berlin (DE)

(21) Appl. No.: 19/572,436

(22) Filed: Mar. 19, 2026

(30) Foreign Application Priority Data
Mar. 19, 2025 (EP) 25164626.1

(51) Int. Cl. F23R 3/38; F02M 25/025; F23C 99/00; F23R 3/42; H02K 7/18

(52) U.S. Cl. CPC F23R 3/38; F02M 25/025; F23C 99/00; F23R 3/42; H02K 7/1823; F23C 2900/99008

(57) ABSTRACT

A method for performing mechanical work. A fuel is combusted in at least one reactor using an oxidizing agent, and mechanical work is performed by expanding in an expander a reaction product resulting from the combustion. Fuel or fuel and oxidizing agent are supplied to the expander to counteract a drop in temperature in the expander during combustion of the fuel in the expander. Furthermore, an arrangement for performing mechanical work via the method and a method for converting mechanical energy into electrical energy, are also provided.

This nonprovisional application claims priority under 35 U.S.C. § 119(a) to European Patent Application No. 25164626.1, which was filed on Mar. 19, 2025, and which is herein incorporated by reference.

### BACKGROUND OF THE INVENTION

### Field of the Invention

The invention relates to a method for performing mechanical work, an arrangement for performing mechanical work, and a method for converting mechanical energy into electrical energy.

### Description of the Background Art

There is an increasing demand for efficient and environmentally friendly methods and arrangements for performing mechanical work, particularly with regard to reducing emissions and conserving fossil resources. Existing methods for performing mechanical work, for example in turbines, which are typically used to convert mechanical energy into electrical energy, often have significant disadvantages. These include inefficient combustion processes, high emission values, and the use of fossil fuels, which lead to further environmental pollution and an increase in the CO₂ content in the atmosphere. The combustion of hydrogen as a fuel in particular offers the potential to overcome these challenges, as hydrogen only produces water as a by-product during combustion. Nevertheless, there are still shortcomings in terms of the efficiency and complete emission-free nature of such processes, which highlights the need for technical solutions in this area.

EP3087324B1, which corresponds to US 2017/0030304, discloses an internal combustion engine and a method for generating energy via expansion work in internal combustion engines, with energy-efficient oxygen supply to the combustion chamber of a self-compressing internal combustion engine. An oxygen storage material is present in the combustion chamber, so that the storage of oxygen in the oxygen storage material in the combustion chamber enables a self-compressing combustion process.

EP3377818B1, which corresponds to US 2018/0334957, is a teaching for increasing the electrical efficiency or the proportion of useful work of gas turbines. This involves wet combustion with oxygen, whereby the oxygen is supplied via mixed-conducting ceramic membranes. The driving force for the passage of oxygen is achieved by lowering the oxygen partial pressure on the permeate side of the membrane module, and the energy required for this is taken from the process energy of the gas turbine process.

WO2012153003A1 discloses a combustion process in which a burner is used that contains one or more parallel tubular, semipermeable burner membranes, wherein the fuel is introduced into the combustion chamber formed by the membranes and both the oxygen and the nitrogen of the combustion air are transported in ionized form through the membrane into the combustion chamber without the aid of a compressor, wherein the fuel reacts with the oxygen of the combustion air.

### SUMMARY OF THE INVENTION

It is therefore an object of the present invention to provide a method for performing mechanical work, an arrangement for performing mechanical work, and a method for converting mechanical energy into electrical energy, each of which is improved with regard to the problem described above.

This task is solved by a method for performing mechanical work, an arrangement for performing mechanical work, and a method for converting mechanical energy into electrical energy.

A first aspect of the invention relates to a method for performing mechanical work, wherein a fuel is combusted in at least one reactor using an oxidizing agent, and mechanical work is performed by expanding in an expander a reaction product resulting from the combustion, characterized in that fuel or fuel and oxidizing agent are supplied to the expander to counteract a drop in temperature in the expander by combustion of the fuel in the expander.

By counteracting the temperature drop in the expander according to the invention by supplying and combusting fuel, the method provides an approximation to an Ericsson cycle with an advantageously increased efficiency. However, as a result of the supply and combustion of fuel or fuel and oxidizing agent in the expander, the temperature in the expander does not necessarily have to be kept constant or increased. In fact, the temperature may continue to decrease. In any case, however, the supply and combustion of fuel or fuel and oxidizing agent in the expander counteracts a drop in temperature to the extent that the drop in temperature is at least reduced, resulting in an advantageously increased efficiency compared to the case without such a supply. Due to the combustion of fuel in the expander according to the invention, the expander can be regarded as an extension of the reactor.

The fuel can be solid fuel or fluid fuel. In the case of fluid fuel, it can be, for example, hydrogen, methane, heating oil, or methanol.

The oxidizing agent may comprise oxygen or be oxygen.

The reaction product resulting from the combustion flows through several stages of the expander in series, and fuel or fuel and oxidizing agent can be fed into at least one of the stages to counteract a temperature drop in the respective stage. Furthermore, it is provided that the reaction product resulting from combustion flows through several stages of the expander in series and fuel or fuel and oxidizing agent are fed into several, i.e., at least two of the stages of the expander, or even into each stage of the expander. The supply can be such that each stage can be supplied with fuel or fuel and oxidizing agent separately and independently of the other stages, e.g., via a pipe assigned to it. This allows the temperature in individual stages to be adjusted specifically and independently of the other stages.

The supply of fuel or fuel and oxidizing agent can be controlled such that a temperature in the expander and/or in the reactor is maintained above a predetermined minimum temperature. Compared to supplying fuel or fuel and oxidizing agent to the expander, which slows down the temperature drop but does not prevent it, this measure leads to an advantageous increase in efficiency. In the case of hydrogen as fuel in the form of a combustion fluid, this minimum temperature can be 800° C., for example. If an expander with several stages is used, the temperature can be maintained above this minimum temperature in at least one of the stages or in all stages. If several stages of the expander are maintained above the same minimum temperature, this brings the process closer to an Ericsson cycle, which advantageously increases efficiency.

Water can be introduced into the reactor to counteract heating of the reactor caused by combustion of the fuel in the reactor and to generate steam, which is also fed to the expander and expanded there.

The supply of water to the reactor can be controlled so that the temperature in the reactor and/or in the expander is kept below a predetermined maximum temperature. In the case of hydrogen as the fuel, this maximum temperature can be, for example, 1000° C.

These measures prevent the temperature in the reactor and/or expander from rising to temperature ranges that would lead to the dissociation of fuel such as hydrogen, and also enable the generation of additional steam in addition to that produced as a reaction product of the fuel or fuel and oxidizing agent, which can perform additional mechanical work as it expands in the expander.

Water can be supplied to the reactor in such a way that the temperature in the reactor and/or in the expander is maintained within a predetermined temperature range. This temperature range can extend between the the minimum temperature and the the maximum temperature. In the case of hydrogen as the combustion fluid, this temperature range can be between 800° C. and 1000° C. Such a temperature range enables an advantageous increase in efficiency due to sufficiently high temperatures, which are still low enough, however, to prevent adverse effects such as dissociation of the combustion fluid.

The fuel comprises oxygen, and the oxygen for combusting the fuel in the reactor and/or the oxygen supplied to the expander is provided by an oxygen storage material which can reversibly absorb and release oxygen. The oxygen storage material may be, for example, a ceramic bulk material. The absorption of oxygen by the oxygen storage material advantageously takes place without pressure, so that no compression work is required to transport the oxygen into the reactor.

The expander can be fed with reaction products from different reactors at least in sections, whereby while one of the reactors feeds the expander with reaction product from combustion, at least one other reactor absorbs oxygen. In this respect, this example enables continuous feeding of the expander with reaction product from different reactors and continuous conversion of mechanical energy into electrical energy in connection with the method according to the third aspect of the invention. For example, two reactors can be used, wherein a first of the two reactors feeds the expander with reaction product, while the second of the two reactors absorbs oxygen. As soon as the oxygen in the first reactor is running low, the second reactor feeds oxygen to the expander and the first reactor removes oxygen. This alternating operation of the reactors enables continuous feeding of the reaction product to the expander. More than two reactors can also be operated in a staggered manner, at least in sections, preferably three reactors, whereby preferably at least one of the reactors always feeds the expander with reaction product at any given time. Compared to two reactors, three reactors enable lower fluctuations in the pressure and temperature of the reaction product during operation.

A directed oxygen flow can be passed over the oxygen storage material for oxygen absorption by the oxygen storage material. This measure allows the absorption of oxygen by the oxygen storage material in the reactor to be optimally optimized. In this way, oxygen can be directed to specific areas of the oxygen storage material in order to bring as large a section of the oxygen storage material as possible, or the entire oxygen storage material, to saturation with oxygen as quickly as possible.

The fuel can comprise fuel fluid, and the fuel fluid for combustion in the reactor and/or the fuel fluid supplied to the expander is provided by a fuel fluid storage material which can reversibly absorb and release fuel fluid. If hydrogen is used as the fuel fluid, the fuel fluid storage material may be, for example, a metal hydride storage device. This can be charged with hydrogen without pressure, so that, advantageously, no compression work needs to be performed for this purpose. Metal-organic frameworks (MOFs) are particularly suitable as gaseous hydrocarbons for use as fuel fluid.

It is also intended that the oxygen for combustion of the fuel fluid in the reactor and/or the oxygen supplied to the expander is provided by the aforementioned oxygen storage material, and that the fuel fluid for combustion in the reactor and/or the fuel fluid supplied to the expander is provided by a fuel fluid storage material. In this respect, no compression work is required for oxygen uptake or fuel fluid uptake in the reactor.

A predetermined ratio between a fuel amount and an oxidizing agent amount, in particular an oxygen amount in the reactor, is set for igniting combustion.

After ignition of the combustion, a supply of fuel can be initiated into the reactor in order to maintain the combustion while oxygen is released from the oxygen storage material into the reactor and/or the expander, and this supply is regulated in such a way that the temperature in the reactor and in the expander, in particular in the stages of the expander, is maintained above the predetermined minimum temperature and/or a pressure at an inlet of the expander is maintained within a predetermined pressure range.

Specifically, it is provided that the predetermined ratio between the amount of fuel and the amount of oxidizer, in particular the amount of oxygen in the reactor, can be set for igniting combustion and that, after ignition of combustion, a supply of fuel to the reactor is initiated in order to maintain combustion while oxygen is released from the oxygen storage material into the reactor and/or the expander, and this supply is regulated in such a way that the temperature in the reactor and/or in the expander is maintained above the the predetermined minimum temperature and/or a pressure at an inlet of the expander is maintained within a predetermined pressure range.

The supply of fuel and/or the release of oxygen can also be regulated in such a way that the temperature in the reactor and in the expander is maintained below the predetermined maximum temperature and/or within the predetermined temperature range.

The introduction of water into the reactor can be controlled so that the temperature in the reactor and/or in the expander remains above the the predetermined minimum temperature and/or a pressure at the inlet of the expander remains within a predetermined pressure range. In the case of hydrogen as the combustion fluid, this pressure range may be between 900 bar and 1100 bar, for example.

The fuel supplied to the expander can be provided as a combustion fluid from a combustion fluid pressure vessel as soon as the pressure in the expander has fallen below the pressure of the combustion fluid pressure vessel as a result of the expansion of the reaction product resulting from combustion. In this combustion fluid pressure vessel, the combustion fluid is at a higher pressure than its surroundings. This can be achieved, for example, by desorption of combustion fluid from a combustion fluid storage material located in the combustion fluid pressure vessel in the sense of a metal hydride storage device, or it can also be produced via a compressor. The release of combustion fluid from the combustion fluid pressure vessel into the expander as soon as the pressure in the expander has fallen below the pressure of the combustion fluid pressure vessel as a result of the expansion of the reaction product enables a particularly exergetically efficient supply of combustion fluid to the expander. The supply can be controlled in individual or multiple stages of the expander. Stages that are closer to the outlet of the expander than to its inlet are particularly suitable for this purpose, as the pressure there has already dropped significantly.

A second aspect of the invention relates to an arrangement for performing mechanical work using the method according to the first aspect of the invention. The arrangement comprises at least one reactor for combusting a fuel and at least one expander in which mechanical work can be performed by expanding the reaction product resulting from the combustion, wherein the expander comprises a supply device via which fuel or fuel and oxidizing agent can be supplied to the expander in order to counteract a drop in temperature in the expander during combustion of the fuel in the expander, wherein the reactor comprises an oxidizing agent storage device, and wherein the expander is connected to the oxidizing agent storage device via the supply device, so that both the combustion of the fuel with consumption of oxidizing agent and the supply of oxidizing agent into the expander can take place by release of oxidizing agent from the oxidizing agent storage device.

The oxidizing agent storage device may be an oxygen storage device, in particular an oxygen storage material which can reversibly absorb and release oxygen.

Since the arrangement for performing mechanical work according to the second aspect of the invention is configured to carry out the method for performing mechanical work according to the first aspect of the invention, the examples of the first aspect of the invention also relate to the second aspect of the invention, and vice versa.

The expander can be formed as a turbine with at least one stage.

The supply device for supplying fuel and/or oxidizing agent can be at least partially formed in one or more turbine blades of the turbine. Each stage of the turbine may have one or more turbine blades. The supply device can be arranged at least partially within a rotational axis of the turbine so that the fuel and/or oxidizing agent can be fed via the rotational axis into the turbine blades of the turbine. On the one hand, this enables the turbine to be driven with fuel and/or oxidizing agent escaping from the turbine blades and, on the other hand, it enables a drop in temperature in the turbine to be counteracted, which advantageously increases efficiency. The supply device may be partially contained in a stator of the turbine, in particular in the turbine casing, either alternatively or in addition to a turbine blade.

The arrangement can comprise a control and/or regulation device which is configured to regulate the temperature and/or pressure in the reactor and/or in the expander via control and/or regulation of at least one of the following: supply of water to the reactor; and/or supplying fuel or fuel and oxidizing agent to the reactor and/or the expander, or to at least one stage of the expander.

At least one turbine blade can comprise at least one cooling channel for the flow of a cooling fluid such as water. In particular, each turbine blade comprises at least one cooling channel for the supply or flow of cooling fluid. The cooling channels can be supplied with water via the axis of rotation of the turbine. Accordingly, the turbine blade in question can be water-cooled during operation of the turbine.

A third aspect of the invention relates to a method for converting mechanical energy into electrical energy, in which the method for performing mechanical work is carried out in accordance with the first aspect of the invention, and the mechanical work is transferred to a generator that converts the mechanical work into electrical energy.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is an example of the methods and arrangement according to the invention, wherein reaction product from two reactors operated in alternating mode and additional oxygen are expanded in a multi-stage expander and the mechanical work performed in the process drives a generator;

FIG. 2 is a cross-section through one of the reactors from FIG. 1;

FIG. 3 is a temperature-entropy (T-S) diagram of an example of the method according to the invention for performing mechanical work;

FIG. 4 shows calculated efficiencies for the method according to the invention for different fuels, as a function of the temperature in the reactor and/or the expander, at a pressure of 900 bar;

FIG. 5 shows calculated efficiencies for the method according to the invention for different fuels, as a function of the temperature in the reactor and/or the expander, at a pressure of 600 bar;

FIG. 6 shows calculated efficiencies for the method according to the invention for various fuels, as a function of the temperature in the reactor and/or the expander, at a pressure of 300 bar;

FIG. 7 shows calculated efficiencies for the method according to the invention for various fuels, as a function of the temperature in the reactor and/or the expander, at a pressure of 300 bar, taking into account the heating value instead of the calorific value;

FIG. 8 shows calculated efficiencies for the method according to the invention for various fuels, as a function of the temperature in the reactor and/or the expander, at a pressure of 100 bar;

FIG. 9 shows calculated efficiencies for the method according to the invention for various fuels, as a function of the temperature in the reactor and/or the expander, at a pressure of 30 bar;

FIG. 10 shows calculated efficiencies for the method according to the invention for various fuels, as a function of the temperature in the reactor and/or the expander, at a pressure of 10 bar; and

FIG. 11 is an example of an expander in the form of a turbine as a component of the arrangement according to the invention, wherein the turbine comprises several water-cooled turbine blades.

### DETAILED DESCRIPTION

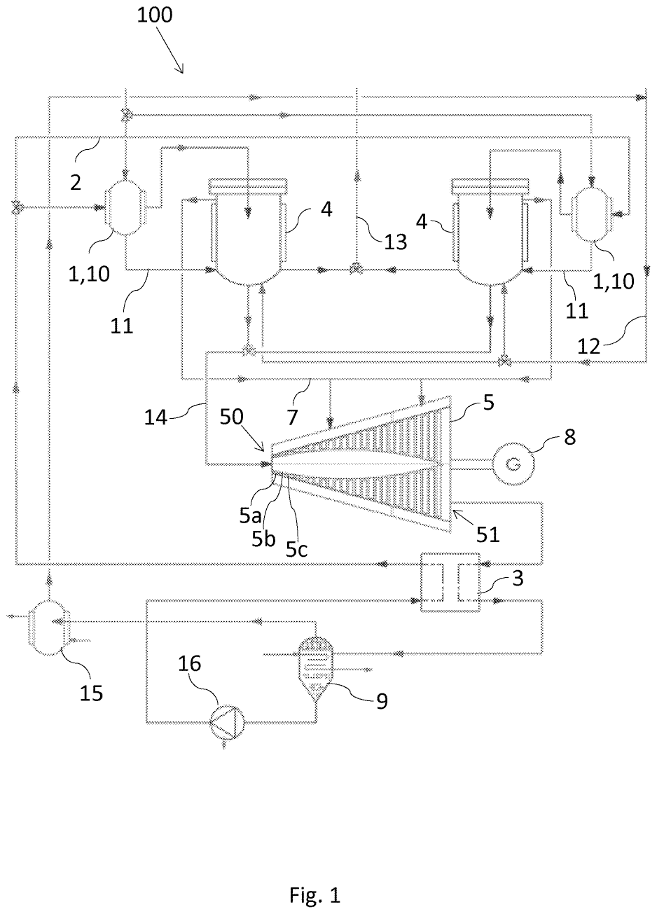

FIG. 1 shows an example of the method according to the invention for performing mechanical work or converting mechanical energy into electrical energy, as well as the arrangement 100 according to the invention for performing mechanical work.

With regard to the components of the arrangement 100 for performing mechanical work according to this example, FIG. 1 shows two reactors 4, to each of which combustion fluid can be supplied via a combustion fluid line 11. In the present example, the combustion fluid is hydrogen (H₂). This is first fed from a hydrogen reservoir, for example a decentralized hydrogen network, into two metal hydride storage units 1, each of which is assigned to one of the two reactors 4. The interior of this storage unit contains iron granules, which can reversibly absorb and release hydrogen. Hydrogen desorbed from the metal hydride storage tanks 1 or from the iron granulate is finally fed into the reactors 4 via the combustion fluid lines 11. The metal hydride storage tanks 1 can be heated via recuperation heat through a heat exchanger 3, which will be referred to in more detail later, thereby releasing the hydrogen.

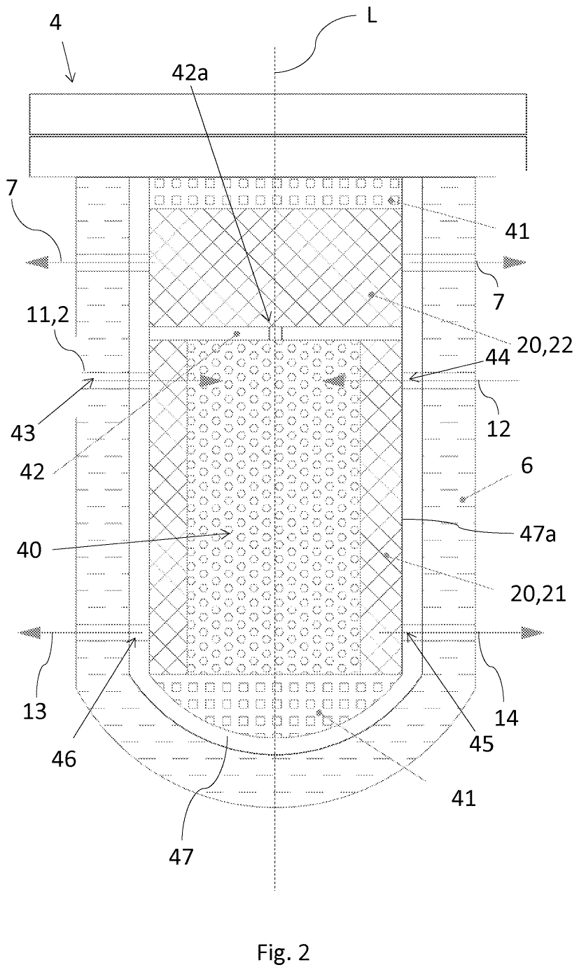

In addition, the arrangement 100 comprises an oxygen line 12 through which oxygen can be supplied to the reactors 4. As explained in more detail in connection with the cross-section of one of the reactors 4 shown in FIG. 2, the reactors 4 may each have oxygen storage material 20 in their interior, which can reversibly absorb and release oxygen, for example a ceramic filling. In this respect, in the present example, air can also be introduced into the reactors 4 via the oxygen line 12, whereby the oxygen storage material 20 located in the reactors 4 can extract at least part of the oxygen content from the air in order to store it in the oxygen storage material 20. The remaining air components, primarily nitrogen, can be removed from the reactors 4 via a nitrogen line 13, also shown in FIG. 1, after the oxygen has been extracted.

To perform mechanical work using the arrangement 100 shown, the combustion fluid is first combusted in at least one of the two reactors 4, consuming oxygen. The reaction product resulting from the combustion, in this case water vapor, is then fed via a reaction product line 14 into an expander 5 of the arrangement 100. In the present example, the expander 5 comprises several stages 5a, 5b, 5c, of which a first stage 5a, a second stage 5b, and a third stage 5c are shown in FIG. 1 as examples. In this respect, the expander 5 shown here with its stages 5a, 5b, 5c may be a turbine with several turbine stages, for example an axial turbine. The turbine stages increase in size radially along the direction of flow, i.e., perpendicular to the axial direction of flow, in order to compensate for the pressure drop of the reaction product as it flows through the turbine and to achieve flow velocities that are as constant as possible in the axial direction. In the expander 5 or its stages 5a, 5b, 5c, mechanical work is performed by expanding the reaction product. In addition, the arrangement 100 may have a distributor connected to the reaction product line 14, via which the reaction product can be controlled and directed into individual or multiple stages 5a, 5b, 5c of the expander 5. The distributor thus makes it possible to feed the reaction product from the reactors 4 not only into the inlet 50 of the expander 5, but also in a controlled manner into stages 5a, 5b, 5c located closer to the outlet 51 of the expander 5, in order to feed reaction product into the correspondingly larger stages 5a, 5b, 5c as the pressure in the reactor 4 decreases. 5c with reaction product as the pressure in reactor 4 decreases. This measure further improves the energy efficiency of the arrangement 100.

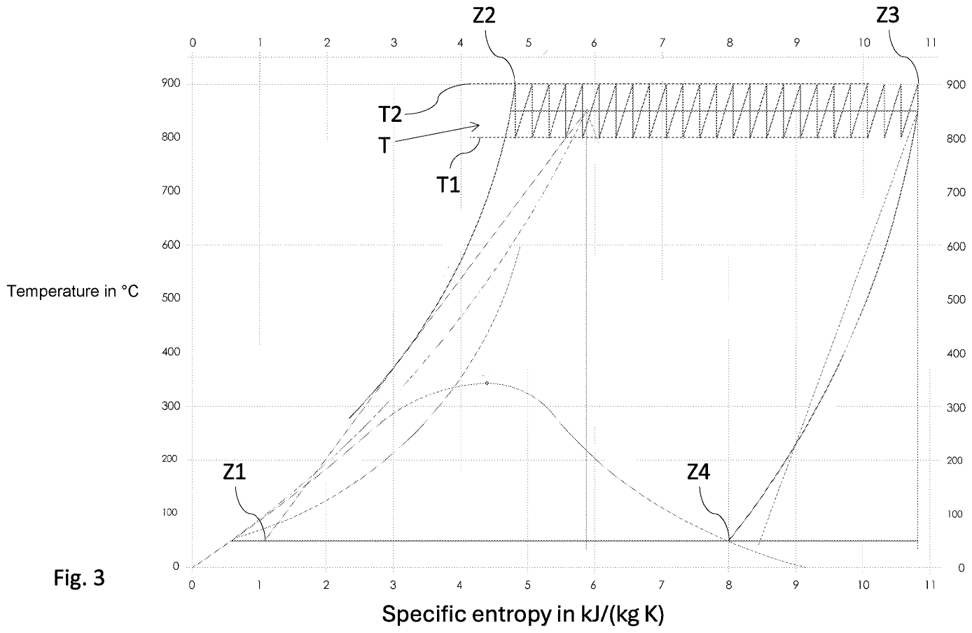

As can also be seen in FIG. 1, the arrangement 100 also comprises a supply device 7, via which combustion fluid or combustion fluid and oxygen are fed to the expander 5 in order to counteract a drop in temperature in the expander 5 by combustion of the combustion fluid in the expander 5. The supply and combustion of fuel fluid in the expander 5 brings the process for performing mechanical work closer to a thermodynamic Ericsson cycle, thereby advantageously increasing the efficiency of the process. The Ericsson cycle is discussed in more detail in FIG. 3.

The arrangement 100 shown in FIG. 1 also comprises a generator 8 to which the mechanical work performed in the expander 5 is transferred, so that mechanical energy can be converted into electrical energy via the generator 8.

In the present example, the expander 5 can be fed with reaction products from the two reactors 4 at different times, whereby, while one of the two reactors 4 feeds the expander 5 with reaction product resulting from combustion, the other reactor 4 absorbs oxygen via the oxygen storage material 20 located therein. This enables continuous operation of the arrangement 100 by alternately feeding the expander 5 with reaction product from the two reactors 4, so that electrical energy can be continuously provided at a high efficiency via the generator 8.

Optionally, the arrangement 100 between the reactors 4 and the expander 5 may comprise at least one, for example five, intermediate storage tanks for temporarily storing the reaction product from the reactors 4. The intermediate storage tanks are not shown in FIG. 1. Temporary storage allows the steam feed to the expander 5 to be further equalized.

As explained in more detail in connection with FIG. 2 and FIG. 3, in the present example, the temperature during combustion in the reactors 4 is maintained within a predefined temperature range, which in the case of hydrogen as the combustion fluid is between 800° C. and 1000° C., for example at 900° C. In order to maintain the temperature in this temperature range after ignition of the combustion, water is fed into the reactors 4 in a controlled manner via a water pipe 2. On the one hand, this leads to the formation of additional water vapor, which is also fed to the expander 5, where it expands and thus performs mechanical work, and on the other hand, it prevents dissociation of the water vapor, which could lead to the formation of hydrogen and hydroxyl radicals and cause material damage in the reactors 4. The supply of water to reactors 4 is also regulated in such a way that the pressure in reactors 4 is within a predefined range, in this case between 900 bar and 1100 bar, for example at 1000 bar. Accordingly, the reaction product and the additional water vapor created by the supply of water have a temperature of approximately 900° C. and a pressure of approximately 1000 bar when they enter the expander 5 via its inlet 50.

After expansion in the expander 5, the water vapor and the combustion fluid or combustion fluid and oxygen additionally fed into the expander 5 via the supply device 7 exit at a temperature of approximately 800° C. and a pressure of 0.1 bar from an outlet 51 of the expander 5 and is fed via a heat exchanger 3 into a first condenser 9. There, the still hot mixture of water vapor and oxygen is cooled, for example by air cooling, in such a way that the water vapor condenses into water and is thus separated from the gaseous oxygen. The water is now passed through the aforementioned heat exchanger 3, where it is heated by the hot water vapor emerging from the expander 5, in order to be fed back into the reactors 4 in a controlled manner via the water pipe 2. In this respect, the water or water vapor forms a conservative working medium that is permanently retained in the process and can be used repeatedly to perform mechanical work or convert mechanical energy into electrical energy. Any excess water produced by the combustion of hydrogen using oxygen can be removed via a water drainage device 16 downstream of the first condenser 9. The oxygen separated from the water vapor in the first condenser 9 is fed into an oxygen pressure vessel 15 and heated there. Oxygen from the oxygen pressure vessel 15 can then be fed back into the oxygen line 12 to supply the reactors 4 with oxygen.

FIG. 2 shows a cross-section through one of the reactors 4 from FIG. 1. The other of the two reactors 4 can be formed accordingly.

In reactor 4, oxygen storage material 20 is formed on the one hand as a first oxygen storage 21, which is arranged on an inner side 47a of a reactor wall 47. The reactor wall 47 and, correspondingly, the first oxygen storage 21 can each be formed at least in sections as hollow cylinders around a longitudinal axis L of the reactor 4. Insulation 41 on an upper side and a lower side of the reactor 4 along the longitudinal axis L reduces heat loss from the reactor 4 to the environment. The first oxygen storage 21 surrounds a combustion chamber 40 of the reactor 4, in which combustion fluid can be combusted using oxygen. For this purpose, the reactor 4 comprises a combustion fluid supply opening 43 in its reactor wall 47, which can be connected or is connected to the combustion fluid line 11 shown in FIG. 1, as well as an oxygen supply opening 44, which can be connected or is connected to the aforementioned oxygen line 12.

As can also be seen in FIG. 2, oxygen storage material 20 in reactor 4 forms a second oxygen storage unit 22 in addition to the first oxygen storage unit 21. This second oxygen storage device 22 supplies oxygen to the expander 5 or its individual stages 5a, 5b, 5c via the supply device 7, which is also visible in FIG. 1, in order to counteract a drop in temperature in the expander 5. The second oxygen storage tank 22 is separated from the first oxygen storage tank 21 by a partition plate 42. The supply of oxygen from the second oxygen storage tank 22 to the expander 5 therefore takes place separately and independently of the supply of the reaction product from the reactor 4 to the expander 5 via the aforementioned reaction product line 14. However, the partition plate 42 comprises a partition plate opening 42a which establishes a connection between the second oxygen storage tank 22 and the combustion chamber 40 of the reactor 4. The baffle plate opening 42a therefore allows pressure equalization between the combustion chamber 40 of the reactor 4 and the space occupied by the second oxygen storage tank 22, which triggers or accelerates the release of oxygen from the second oxygen storage tank 22. In addition, the second oxygen storage tank 22 can be flooded with oxygen-containing gas, in particular air, via the opening in order to recharge the second oxygen storage tank 22 with oxygen after discharge.

To operate the reactor 4, the oxygen storage material 20 in the first and second oxygen storage tanks 21, 22 is first charged with oxygen. For this purpose, air can be fed into the combustion chamber 40 of the reactor 4 via the oxygen line 12 and the oxygen supply opening 44, whereby the oxygen present in the air is at least partially absorbed by the oxygen storage material 20 of the first and second oxygen storage tanks 21, 22. Once the oxygen storage material 20 is saturated and can no longer absorb any more oxygen, the oxygen—together with the other air components such as nitrogen, if applicable—can be discharged from the reactor 4 via a nitrogen discharge opening 46 and fed into the nitrogen line 13 also shown in FIG. 1. For the combustion of fuel fluid and oxygen, a predetermined ratio between a corresponding amount of fuel fluid and an amount of oxygen is first set in the reactor 4. After ignition, the combustion of hydrogen and oxygen produces water vapor and heat as reaction products, whereby the water vapor can escape from the reactor 4 via a reaction product outlet 45 and is fed via the reaction product line 14 and the distributor, also shown in FIG. 1, into the expander 5, where it is expanded. In order to avoid excessive temperatures and thus the formation of free radicals within the reactor 4, it is cooled from the outside with water 6. In addition, water 6 is sprayed into the reactor 4 via the combustion fluid supply opening 43. The water 6 can be kept at a supercritical level by a feed pump upstream of the reactors 4. The water 6 is supplied in such a way that the temperature in the reactor 4 remains within a predetermined temperature range. In the case of hydrogen as the fuel fluid, this can be between 800° C. and 1000° C., for example. Under these thermal conditions, dissociation of the water vapor as a reaction product is avoided and, in addition to the water vapor as a reaction product of hydrogen and oxygen, additional water vapor is formed by the water 6 sprayed into reactor 4, which is also fed to the expander 5 and expanded there.

The amount of fuel fluid—in this example, the amount of hydrogen—in reactor 4 prior to ignition is adjusted stoichiometrically to a free amount of oxygen in reactor 4 that is not bound by the first and/or second oxygen storage units 21, 22. After ignition, additional fuel fluid or hydrogen is fed into reactor 4. This takes into account the sudden rise in temperature in reactor 4, whereby additional oxygen bound in the first oxygen storage unit 21 around the combustion chamber 40 is desorbed due to heat input into the oxygen storage material 20 and gradually diffuses into the combustion chamber 40. In accordance with this continuous release of oxygen from the first oxygen storage tank 21, additional fuel fluid or hydrogen can be supplied at a low pressure level, which is converted into the reaction product 3, in this case water vapor.

The desorption of oxygen from the inner surface of the oxygen storage material 20 occurs spontaneously when a desorption temperature of approx. 200° C. is reached, but increasingly depends on the heat supply from the combustion chamber 40. The heat supply is inhibited by the limited thermal conductivity of the oxygen storage material 20. The pore diffusion of oxygen into the combustion chamber 40 is also inhibited by the low diffusion rate. The resulting time delays are used in the present case to maintain the temperature level at least temporarily in the the temperature range between 800° C. and 1000° C., for example at 900° C., when the amount of hydrogen stored in the reactor 4 exceeds the amount of free oxygen at the time of ignition and is sufficient to vaporize the continuously supplied water 6. Under these conditions, water vapor can be temporarily extracted from reactor 4 at an approximately constant temperature and approximately constant pressure. Accordingly, the reaction process is at least partially continuous, which favors the implementation of an Ericsson cycle. With a temporary drop in pressure in reactor 4, the reaction product can be fed in a controlled manner via the distributor to the corresponding pressure stages 5a, 5b, 5c of the expander 5 until the pressure level at the outlet 51 of the expander 5 is reached. The remaining content can then be fed to the heat exchanger 3 described in FIG. 1. In accordance with the time-delayed desorption behavior of oxygen described here, the “consumption” of oxygen in connection with the present invention is to be understood as meaning that at least temporarily a supply of oxygen is available for combustion, whereby an amount of oxygen present before combustion does not necessarily have to be completely consumed in the course of combustion.

FIG. 3 shows a temperature-entropy (T-S) diagram for the method according to the invention for performing mechanical work. The supply of fuel fluid or fuel fluid and oxygen to the expander 5 counteracts a temperature drop in the expander 5 due to the combustion of the fuel fluid in the expander 5, thus bringing the process closer to an Ericson cycle with essentially four state changes. These state changes will be explained below using the four states Z1, Z2, Z3, Z4 shown in FIG. 3.

In a first change of state from a first state Z1 to a second state Z2, fuel fluid is combusted in reactor 4 with consumption of oxygen, whereby a partially isochoric compression of the fuel fluid and the oxygen occurs in reactor 4 with an increase in temperature from, for example, 50° C. to 900° C. In order to prevent the temperature of the second state Z2 from rising significantly above 900° C., water 6 is fed into reactor 4, as explained in FIG. 1 and FIG. 2. The water vapor produced during combustion now leaves reactor 4 and is fed into expander 5 at a pressure of approximately 1000 bar and a temperature of approximately 900° C.

If no further measures are taken, there would now be an abrupt drop in temperature within the expander 5, so that a corresponding cycle would only occupy a small area in the T-S diagram and consequently offer only a low degree of efficiency. According to the invention, however, fuel, in particular fuel fluid or fuel, and oxidizing agent, in particular oxygen, are supplied to the expander 5 in order to counteract a drop in temperature in the expander 5 by combustion of the fuel fluid in the expander 5. This supply slows down the temperature drop in the expander 5 and thus leads to a larger area of the T-S diagram compared to the case without such a supply, thereby advantageously increasing the efficiency. Specifically, it is provided that fuel or fuel and oxidizing agents are supplied separately to each of the stages 5a, 5b, 5c of the expander 5 in order to counteract a temperature drop in the respective stage 5a, 5b, 5c. In this case, the change of state from the second state Z2 to a third state Z3 in the T-S diagram proceeds via a series of successive temperature drops and temperature rises, whereby each temperature drop and the immediately following temperature rise corresponds to the temperature curve within a single stage 5a, 5b, 5c of the expander 5. For the T-S diagram, this means that the change of state from the second state Z2 to the third state Z3 is extended to significantly higher entropy values than would be expected without the supply of fuel or fuel and oxidizing agent. Accordingly, the efficiency of this process, which now approximates an Ericsson cycle, is significantly increased. The number of stages 5a, 5b, 5c is primarily determined by the pressure at the inlet 50 of the expander before its first stage 5a. As a result of the controlled supply of fuel or fuel and oxidant to the individual stages 5a, 5b, 5c, a temperature in a temperature range T between a minimum temperature T1, which in the present example is 800° C. for hydrogen as the fuel fluid, and a maximum temperature T2, which in the present case is 900° C., is established there. Accordingly, the temperature during expansion in the expander 5 is kept approximately constant in the style of an Ericsson cycle.

At the outlet 51 of the expander 5 behind its last stage, the pressure in the third state Z3 has dropped to approx. 0.1 bar while the temperature is still high. The hot reaction product finally leaves the expander 5 and cools down via state Z4 or condenses in the first condenser 9 shown in FIG. 1 before the cycle returns to the first state Z1 and starts again from the beginning.

Under the temperature and pressure conditions mentioned, thermal efficiencies of approx. 90% can be achieved. Actual efficiencies would be between 81% and 72%.

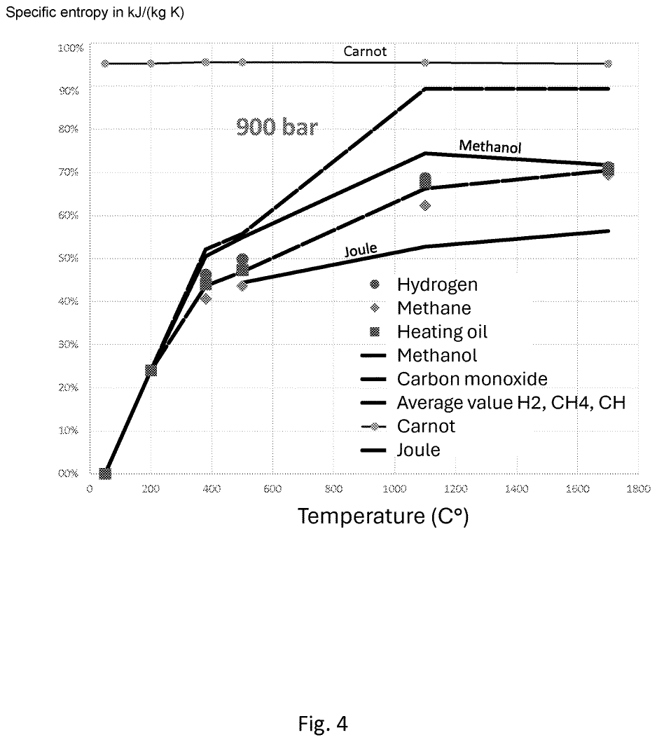

FIG. 4 shows calculated efficiencies for the method according to the invention for different fuels as a function of the temperature in the reactor 4 and expander 5. The efficiencies were calculated for hydrogen, methane, fuel oil, methanol, and carbon monoxide for a pressure of 900 bar in the reactor 4 and taking into account the water supply for cooling the reactor 3. Cooling is provided to maintain the temperature in reactor 4 and expander 5 within a range that does not lead to the dissociation of water or damage to the reactor or expander 5.

The calculated values are compared with an idealized Carnot process, whose efficiency here is 95%. The efficiency increases continuously for all fuels with temperature, with methanol in particular, as a sustainably producible fuel fluid, exhibiting the highest efficiencies for a given temperature alongside carbon monoxide. The use of zeolite can increase the efficiency by a further 5% in each case.

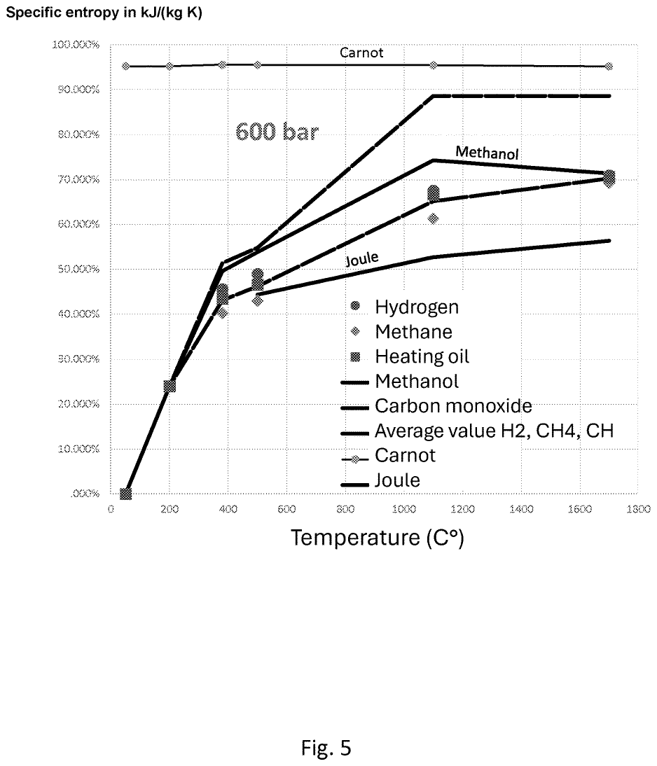

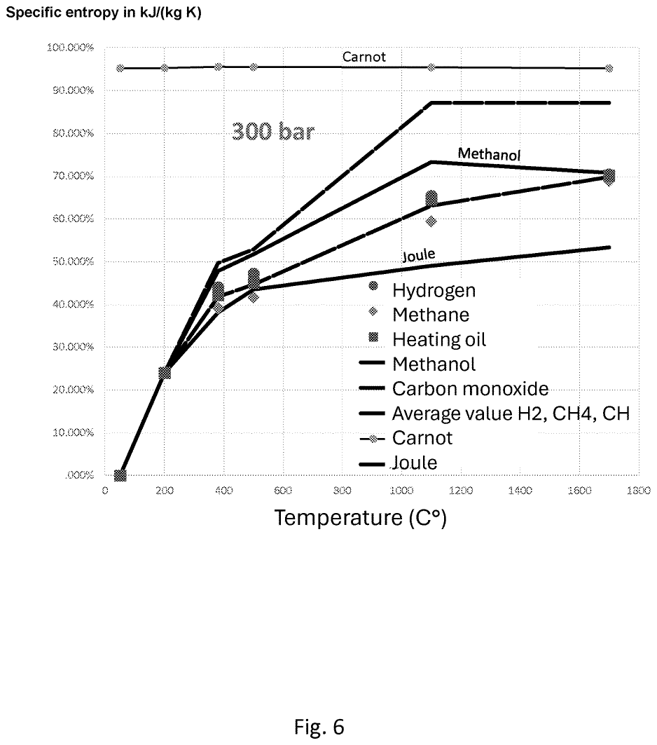

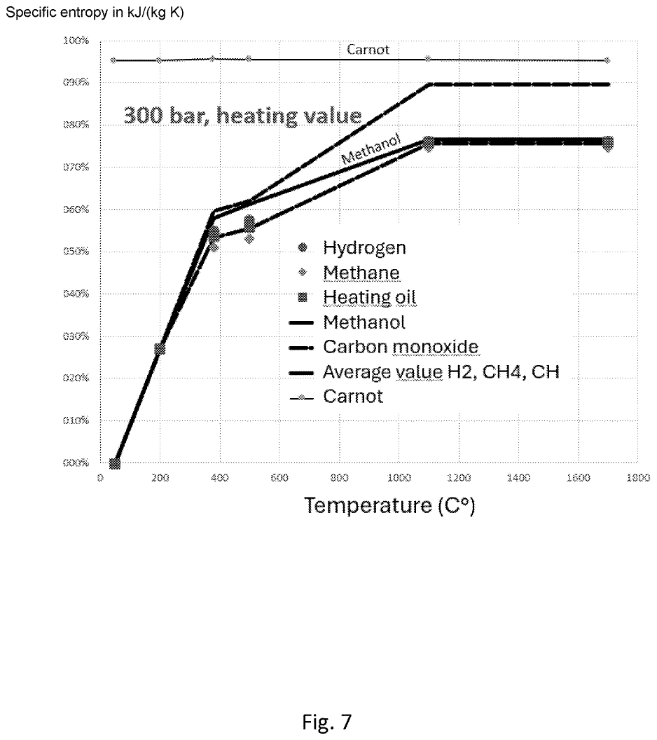

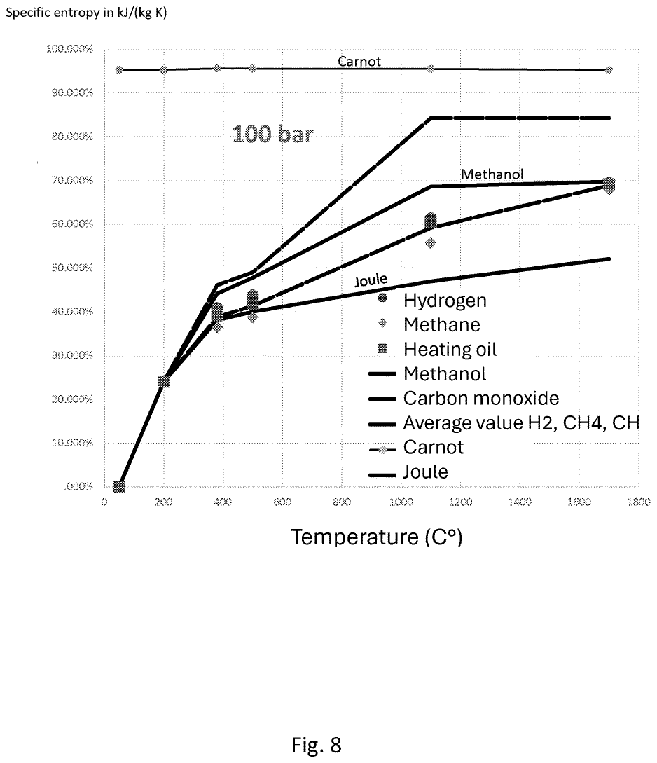

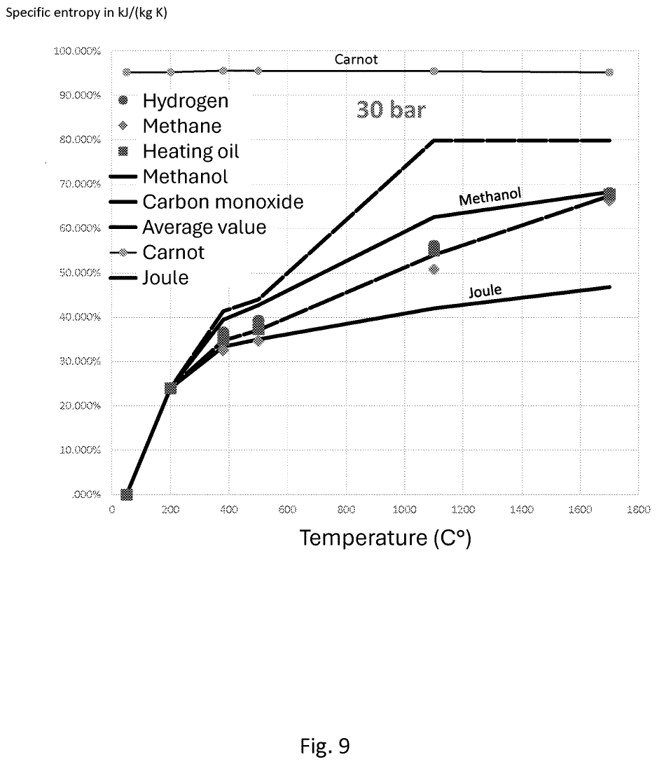

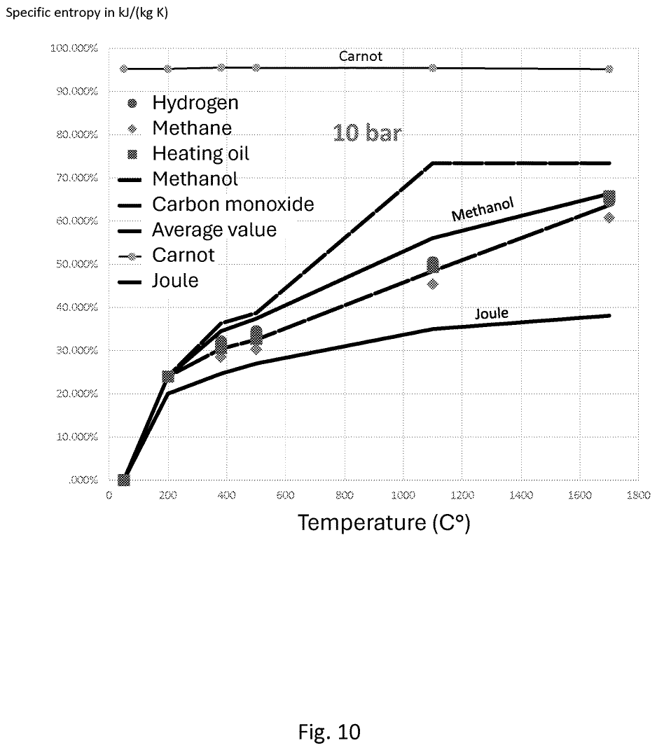

FIG. 5 shows the correspondingly calculated efficiencies for a pressure of 600 bar in reactor 4, FIG. 6 shows the correspondingly calculated efficiencies for a pressure of 300 bar in reactor 4, FIG. 7 shows the correspondingly calculated efficiencies for a pressure of 300 bar in reactor 4, as in FIG. 6, whereas for the calculation in FIG. 6, instead of the heating value as in FIG. 7 and FIGS. 5 and 8 to 10, the calorific value was considered, which, in addition to the heating value, also takes into account the heat of condensation that arises when the combustion exhaust gases cool and condense. FIG. 8 shows the correspondingly calculated efficiencies for a pressure of 100 bar in reactor 4, FIG. 9 shows the correspondingly calculated efficiencies for a pressure of 30 bar in reactor 4, and FIG. 10 shows the correspondingly calculated efficiencies for a pressure of 10 bar in reactor 4. The efficiencies decrease systematically with decreasing pressure in reactor 4 and increase with temperature for a given pressure. Methanol, in addition to carbon monoxide, should be highlighted as the fuel with the highest achievable efficiencies for all calculations.

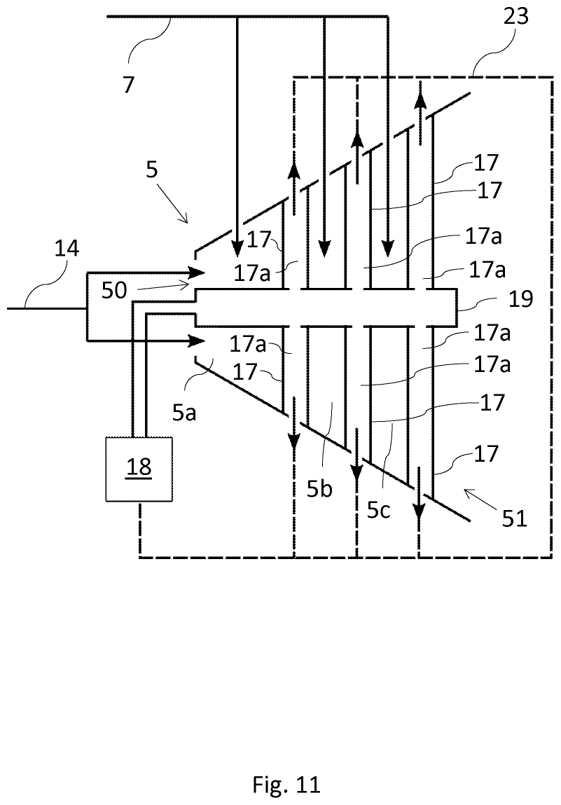

FIG. 11 shows an example of an expander 5 in the form of a turbine as part of the arrangement 100 according to the invention, wherein the turbine comprises several water-cooled turbine blades 17. The turbine blades 17 each separate two adjacent stages 5a, 5b, 5c of the turbine. FIG. 5 shows three stages 5a, 5b, 5c of the turbine as an example, but the turbine may have more than three stages 5a, 5b, 5c. The supply device 7 can be used to supply the individual stages 5a, 5b, 5c with fuel or fuel and oxidizing agent in a controlled manner in order to counteract a drop in temperature in the stages 5a, 5b, 5c.

Reaction product from the reaction product line 14 enters the turbine via the inlet 50 of the turbine and expands in the direction of the outlet 51 of the turbine. A rotational axis 19 of the turbine simultaneously forms a feed line for water from a water reservoir, in particular from a second condenser 18. The turbine blades 17 each comprise at least one cooling channel 17a, which is connected to the axis of rotation 19 in terms of fluid technology, so that water can be fed through the cooling channels 17a to cool the turbine blades 17. This enables efficient cooling of the turbine blades 17 and thus operation of the turbine even at high temperatures, for example in the range between 1000° C. and 1800° C., where the efficiency of the method according to the invention is particularly high (see FIGS. 4 to 10). The water conducted through the cooling channels 17a can exit the turbine radially through openings and, in particular, be fed back into the second condenser 18 and finally into the turbine in a cooling circuit via a return line 23.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for performing mechanical work, the method comprising:
combusting a fuel in at least one reactor using an oxidizing agent;
performing mechanical work by expanding in an expander a reaction product resulting from the combustion; and
supplying fuel or fuel and oxidizing agent to the expander to counteract a drop in temperature in the expander by combustion of the fuel in the expander.

2. The method for performing mechanical work according to claim 1, wherein the reaction product resulting from combustion flows serially through several stages of the expander in series, and wherein fuel and/or oxidizing agent is supplied to at least one of the stages in order to counteract a drop in temperature in the respective stage.

3. The method for performing mechanical work according to claim 1, wherein the supply of fuel or fuel and oxidizing agent is controlled such that a temperature in the expander is maintained above a predetermined minimum temperature.

4. The method for performing mechanical work according to claim 1, wherein water is introduced into the reactor in order to counteract heating of the reactor caused by combustion of the fuel in the reactor and to generate water vapor, which is also fed to the expander and expanded there.

5. The method for performing mechanical work according to claim 1, wherein the oxidizing agent comprises oxygen and wherein the oxygen for combustion of the fuel in the reactor and/or the oxygen supplied to the expander is provided by an oxygen storage material adapted to reversibly absorb and release oxygen.

6. The method for performing mechanical work according to claim 5, wherein the expander is fed, at least intermittently, with reaction products from different reactors resulting from combustion, and wherein, while one of the reactors is feeding the expander with reaction product resulting from combustion, at least one other reactor absorbs oxygen.

7. The method for performing mechanical work according to claim 1, wherein the fuel comprises a combustion fluid and wherein the combustion fluid for combustion in the reactor and/or the combustion fluid supplied to the expander is provided by a combustion fluid storage material adapted to reversibly absorb and release combustion fluid.

8. The method for performing mechanical work according to claim 5, wherein a predetermined ratio between a fuel quantity and an oxygen quantity in the reactor is set for ignition of the combustion, and wherein, after ignition of the combustion, a supply of fuel is provided to the reactor to maintain the combustion, while oxygen is supplied from the oxygen storage material to the reactor and/or the expander, and wherein this supply is controlled such that the temperature in the reactor and/or in the expander is maintained above the predetermined minimum temperature and/or a pressure at an inlet of the expander is maintained within a predetermined pressure range.

9. The method for performing mechanical work according to claim 4, wherein the introduction of water into the reactor is controlled such that the temperature in the reactor and/or in the expander remains above the predetermined minimum temperature and/or a pressure at the inlet of the expander remains within a predetermined pressure range.

10. The method for performing mechanical work according to claim 1, wherein the fuel supplied to the expander comprises a combustion fluid, and wherein the combustion fluid is provided from a combustion fluid pressure vessel as soon as a pressure in the expander has fallen below a pressure of the combustion fluid pressure vessel as a result of the expansion of the reaction product resulting from combustion.

11. An arrangement to perform mechanical work using the method according to claim 1, the arrangement comprising:
at least one reactor to combust a fuel, the at least one reactor comprising an oxidizing agent storage; and
at least one expander in which mechanical work is performed by expansion of the reaction product resulting from combustion, the at least one expander comprising a supply device via which fuel or fuel and oxidizing agent is adapted to be supplied to the expander to counteract a temperature drop in the expander by combustion of the fuel in the expander,
wherein the expander is connected to the oxidizing agent storage via the supply device such that both the combustion of the fuel with consumption of oxidizing agent and the supply of the oxidizing agent to the expander takes place by releasing oxidizing agent from the oxidizing agent storage.

12. The arrangement according to claim 11, wherein the expander is formed as a turbine with at least one stage.

13. The arrangement according to claim 12, wherein the supply device for supplying fuel or fuel and oxidizing agent is at least partially formed in one or more turbine blades of the turbine.

14. The arrangement according to claim 12, wherein at least one turbine blade comprises at least one cooling channel for a flow of a cooling fluid.

15. A method for converting mechanical energy into electrical energy, the method comprising:
performing mechanical work according to the method of claim 1; and
transferring the mechanical work to a generator that converts the mechanical work into electrical energy.
